(19) United States
(12) Patent Application Publication
(10) Pub. No.: US 2013/0315406 A1
(43) Pub. Date: Nov. 28, 2013

(54) SYSTEM AND METHOD FOR DATA PROCESSING USING EARPHONE PORT

(71) Applicant: Research & Business Foundation Sungkyunkwan University, Suwon-si (KR)

(72) Inventors: Jae Boong CHOI, Yongin-si (KR); Sang Mo YANG, Seoul (KR); Dae Geun CHO, Chungju-si (KR); Jung Min LEE, Hanam-si (KR); Sang Hun SUL, Seoul (KR); Kyung Shik OH, Suwon-si (KR)

(73) Assignee: Research & Business Foundation Sungkyunkwan University, Suwon-si (KR)

(21) Appl. No.: 13/899,951

(22) Filed: May 22, 2013

(30) Foreign Application Priority Data
May 22, 2012 (KR) 2012-0054238

(51) Int. Cl. H04R 29/00

(52) U.S. Cl. CPC H04R 29/001
USPC 381/58

(57) ABSTRACT

In order to solve the above-described problem, the present disclosure provides a system and a method for signal processing with an external smart device using an earphone port. The earphone port includes a speaker terminal and a microphone terminal and receives a signal from an earphone plug of the peripheral device connected to the smart device. The connection recognition unit recognizes a connection between the earphone plug of the peripheral device and the earphone port. The application operating unit receives an executive command of an existing signal processing application through an input module and executes the signal processing application in response to the executive command. The data processing unit performs a predetermined signal analysis on a data signal input from the peripheral device through the microphone terminal according to an operation of the executed signal processing application and outputs a result of the signal analysis through an output module.

### CROSS-REFERENCE TO RELATED APPLICATION

This application claims the benefit of Korean Patent Application No. 2012-0054238 filed on May 22, 2012, the entire disclosures of which are incorporated herein by reference.

### FIELD OF THE INVENTION

The present disclosure relates to a system including a smart device and a peripheral device for signal processing using an earphone port and a method thereof.

### BACKGROUND OF THE INVENTION

As a wireless communication technology continuously develops and a semiconductor manufacturing technology is improved, a portable terminal has a tendency toward weight lightening, compaction, and multi-functionalization. Actually, a portable terminal has become one of communications devices indispensable to daily life.

Most portable terminals include an earphone port which can be connected with an external earphone-microphone set for the sake of safe and convenient movement. Such an earphone port is a terminal having a standardized size and shape.

Meanwhile, recently, with the development of a wireless internet technology, a smart portable terminal, such as a smart phone, capable of executing various applications has come into the spotlight.

Such a smart portable terminal includes an advanced user interface and performs data processing with a peripheral device by using wired and wireless data communication means such as a USB and Bluetooth.

However, when a conventional smart portable terminal performs data processing with a peripheral device, a communication interface port corresponding to the peripheral device is required. The peripheral device needs its own power supply such as a battery or the like and uses a complicated communication protocol for data processing with the smart portable terminal.

Therefore, there has been demanded a system and a method capable of simply performing data processing by using an earphone port standardized with respect to various kinds of smart portable terminals and peripheral devices and also capable of supplying power to the peripheral devices.

Meanwhile, regarding a technology of the present disclosure, Korean Patent No. 0819270 (entitled “Earmicrophone apparatus for supplying power to a mobile terminal and the mobile terminal”) describes that an earmicrophone apparatus further includes a second plug for connection with an external power supply in addition to a first plug for connection with an earphone and a microphone and power between different portable terminals is connected in parallel with each other.

### BRIEF SUMMARY OF THE INVENTION

In order to solve the above-described problem, the present disclosure provides a system and a method for signal processing with an external smart device using an earphone port.

In accordance with an aspect of illustrative embodiments, there is provided a smart device that includes an earphone port, a connection recognition unit, an application operating unit, and a data processing unit. The earphone port includes a speaker terminal and a microphone terminal and receives a signal from an earphone plug of the peripheral device connected to the smart device. The connection recognition unit recognizes a connection between the earphone plug of the peripheral device and the earphone port. The application operating unit receives an executive command of an existing signal processing application through an input module and executes the signal processing application in response to the executive command. The data processing unit performs a predetermined signal analysis on a data signal input from the peripheral device through the microphone terminal according to an operation of the executed signal processing application and outputs a result of the signal analysis through an output module.

Further, in accordance with another aspect of the illustrative embodiments, there is provided a signal processing method using an earphone port in which a smart device processes a signal with respect to a peripheral device by using an earphone port. The signal processing method includes recognizing a connection between the earphone port including a speaker terminal and a microphone terminal and an earphone plug of the peripheral device, supplying a voltage of a predetermined level through the microphone terminal or the speaker terminal according to an operation of an existing signal processing application,

receiving a data signal from the peripheral device through the microphone terminal, performing a predetermined signal analysis on the received data signal from the peripheral device according to an operation of the signal processing application, and outputting a result of the signal analysis through an output module.

Furthermore, in accordance with still another aspect of the illustrative embodiments, there is provided a data processing device that includes an earphone plug, a data generation processing unit, a signal generation unit, a signal modulation unit, and a signal output unit. The earphone plug includes a data signal output terminal. The data generation processing unit generates data for operating a signal processing application installed in the external smart device connected through the earphone plug. The signal generation unit generates an analogue signal having a predetermined frequency. The signal modulation unit modulates the analogue signal based on the data generated by the data generation processing unit. The signal output unit outputs the signal modulated by the signal modulation unit through the data signal output terminal, wherein when the earphone plug is connected to the earphone port of the external smart device, the data signal output terminal is connected to a microphone terminal of the earphone port.

Moreover, in accordance with still another aspect of the illustrative embodiments, there is provided a data processing method of a data processing device connected to an earphone port of an external smart device through an earphone plug. The signal processing method includes

receiving a voltage supplied from the external smart device through a power supply terminal of the earphone plug or a data signal output terminal and using the voltage as operation power, generating data for operating a signal processing application installed in the external smart device, modulating analogue signal having a predetermined frequency based on the data, and outputting the modulated signal through a data signal output terminal of the earphone plug, wherein when the earphone plug is connected to the earphone port of the external smart device, the power supply terminal is connected to a speaker terminal of the earphone port and the data signal output terminal is connected to a microphone terminal of the earphone port.

In accordance with one of the illustrative embodiments, by using an earphone port of a smart device, it is possible to receive and transmit a data signal with a peripheral device and also possible to supply a voltage to the peripheral device.

Further, in accordance with one of the illustrative embodiments, it is possible to receive and transmit a signal without addition of functionality and modification to shape of an existing earphone port of a smart device.

Furthermore, in accordance with one of the illustrative embodiments, even if a peripheral device connected to a smart device through an earphone plug does not include an additional power supply, the peripheral device can receive a voltage supplied from a speaker terminal or a microphone terminal of an earphone port through the earphone plug and use the received voltage as power.

Moreover, in accordance with one of the illustrative embodiments, a smart device executes a signal processing application that performs signal analyses respectively predetermined with respect to various peripheral devices connected to the smart device through an earphone port. Thus it is possible to rapidly and conveniently perform signal processing with respect to the peripheral devices.

Besides, in accordance with one of an illustrative embodiments, a data processing apparatus (for example, a peripheral device of the smart device) connected to another device (for example, a smart device) through an earphone plug modulates generated data with a predetermined frequency and transmits the data to the another device through the earphone plug. Thus, it is possible to conveniently receive and transmit a signal between the devices.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 is a block diagram illustrating a configuration of a signal processing system using an earphone port in accordance with an illustrative embodiment.

FIG. 2 is a block diagram for explaining configurations of an earphone port of a smart device and an earphone plug of a peripheral device in accordance with an illustrative embodiment.

FIG. 3 is a block diagram illustrating a configuration of a data processing unit of a smart device in accordance with another illustrative embodiment.

FIG. 4 is a block diagram illustrating a configuration of a data processing unit of a peripheral device in accordance with another illustrative embodiment.

FIG. 5 is a flow chart for explaining a signal processing method of a smart device using an earphone port in accordance with an illustrative embodiment.

FIG. 6 is a flow chart for explaining a data processing method of a peripheral device in accordance with an illustrative embodiment.

FIG. 7 is a flow chart for explaining a signal processing method of a smart device using an earphone port in accordance with another illustrative embodiment.

FIG. 8 is a flow chart for explaining a data processing method of a peripheral device in accordance with another illustrative embodiment.

### DETAILED DESCRIPTION OF THE INVENTION

Hereinafter, examples of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements unless context dictates otherwise.

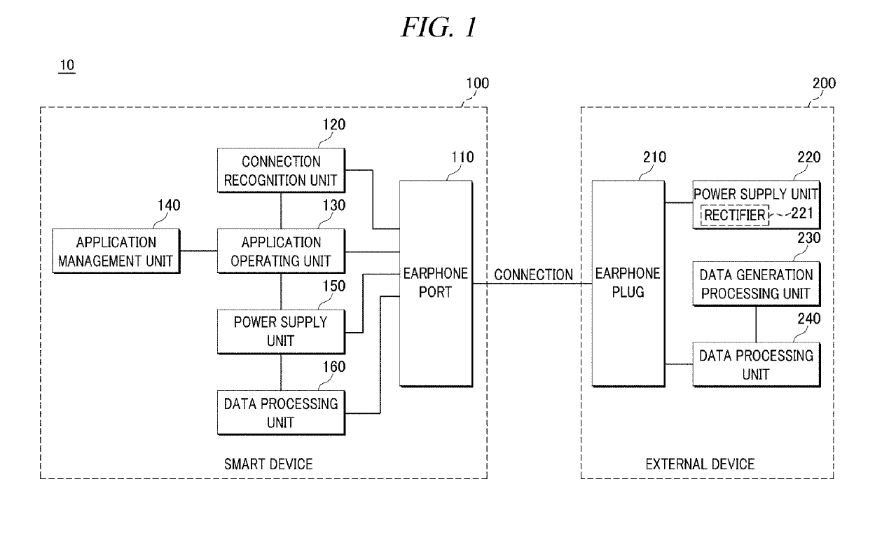

FIG. 1 is a block diagram illustrating a configuration of a signal processing system using an earphone port in accordance with an illustrative embodiment.

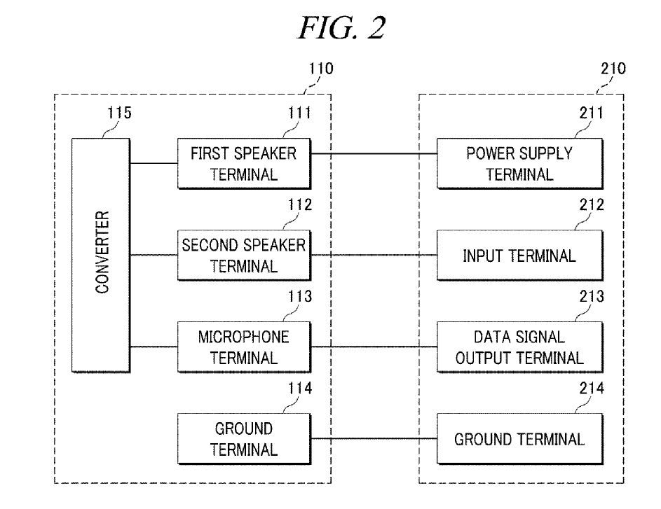

Further, FIG. 2 is a block diagram for explaining configurations of an earphone port of a smart device and an earphone plug of a peripheral device in accordance with an illustrative embodiment.

As depicted in FIG. 1, a signal processing system 10 in accordance with an illustrative embodiment is comprised of a smart device 100 including an earphone port 110 and an external device 200 including an earphone plug 210.

The smart device 100 in accordance with an illustrative embodiment outputs or receives audio signals, and various applications can be installed and executed therein. By way of example, the smart device 100 may include a smart phone.

The external device 200 in accordance with an illustrative embodiment is a data processing device that is connected to the smart device 100 and performs data communication to execute various programs. By way of example, the external device 200 may include a peripheral device (a printer, a key board, a joystick, and a sensor) of a smart phone. Hereinafter, for convenience of explanation, an external device 200 that is connected to another device through an earphone plug and performs data communication will be referred to as the peripheral device 200.

In accordance with an illustrative embodiment, as depicted in FIG. 1, the earphone port (i.e. an earphone jack) 110 of the smart device 100 is connected to the earphone plug 210 of the peripheral device 200. Signals communicated between the earphone port 110 and the earphone plug 210 are respectively processed by the smart device 100 and the peripheral device 200.

To be specific, as depicted in FIG. 1, the smart device 100 in accordance with an illustrative embodiment includes the earphone port 110, a connection recognition unit 120, an application operating unit 130, an application management unit 140, a power supply unit 150, and a data processing unit 160. As depicted in FIG. 2, the earphone port 110 of the smart device 100 includes a first speaker terminal 111, a second speaker terminal 112, a microphone terminal 113, a ground terminal 114, and a converter 115.

The peripheral device 200 in accordance with an illustrative embodiment includes the earphone plug 210, a power supply unit 220, a data generation processing unit 230, and a data processing unit 240. As depicted in FIG. 2, the earphone plug 210 of the peripheral device 200 includes a power supply terminal 211, a data signal output terminal 213, and a ground terminal 214, and may further include an input terminal 212.

Hereinafter, a connection status between the earphone port 110 of the smart device 100 and the earphone plug 210 of the peripheral device 200 will be explained before explanation of a signal processing method between the smart device 100 and the peripheral device 200 in accordance with an illustrative embodiment.

As depicted in FIG. 2, when the earphone port 110 of the smart device 100 is connected to the earphone plug 210 of the peripheral device 200, at least one of the first and second speaker terminals 111 and 112 is connected to the power supply terminal 211 of the earphone plug 210. For reference, although not illustrated in FIG. 2, respective connected relations between the first and second speaker terminals 111 and 112, the power supply terminal 211, and a clock terminal (not illustrated) may be crossed.

Regarding a signal processing method between the smart device 100 and the peripheral device 200 in accordance with another illustrative embodiment, FIG. 2 shows that the first speaker terminal 111 is connected to the power supply terminal 211 or the input terminal 212. However, the second speaker terminal 112 may be connected to the power supply terminal 211 or the input terminal 212. That is, any one of the first and second speaker terminals 111 and 112 of the earphone port 110 may be used (i.e. if a speaker terminal is used for supplying power as described below). Further, although not illustrated in FIG. 2, the earphone plug 210 may further include a clock terminal (not illustrated) that receives a clock signal for synchronization of data communication. In this case, the second speaker terminal 112 is connected to the power supply terminal 211 or the input terminal 212, and the first speaker terminal 111 is connected to the clock terminal (not illustrated), and, thus, respective connected relations may be crossed.

Further, the microphone terminal 113 of the earphone port 110 is connected to the data signal output terminal 213 of the earphone plug 210, and the ground terminals 114 and 214 of the earphone port 110 and the earphone plug 210, respectively, are connected to each other.

If the earphone port 110 is connected to the earphone plug 210 as described above, a signal can be received and transmitted and a data signal can be processed between the smart device 100 and the peripheral device 200 by using the earphone port.

Meanwhile, the first and second speaker terminals 111 and 112 of the earphone port 110 are configured to output audio signals to both sides (i.e. left and right sides) when the smart device 100 outputs audio signals. In particular, in accordance with an illustrative embodiment, the power supply unit 150 outputs a voltage signal toward the peripheral device 200 through any one of the first and second speaker terminals 111 and 112.

In accordance with another illustrative embodiment, the data processing unit 110 transmits an analogue signal to the peripheral device 200 through any one of the first and second speaker terminals 111 and 112.

The smart device 100 receives audio signals through the microphone terminal 113. In accordance with an illustrative embodiment, a data signal is input from the peripheral device 200 through the microphone terminal 113 and transmitted to the data processing unit 160.

The above-described first and second speaker terminals 111 and 112 and the microphone terminal 113 of the earphone port 110 can be connected individually to the converter 115. The converter 115 converts a digital signal into an analogue signal and outputs it through the first and second speaker terminals 111 and 112 and converts an analogue signal received through the microphone terminal 113 into a digital signal.

The ground terminal 114 outputs a ground voltage to the ground terminal 214 of the peripheral device 200.

Meanwhile, the earphone plug 210 has an identical or similar configuration to that of an earphone plug typically used when the smart device 110 receives and outputs audio signals (for example, video sound source and MP3 or the like).

The power supply terminal 211 of the earphone plug 210 receives a voltage output from the first speaker terminal 111 of the earphone port 110 and transmits it to the power supply unit 220 of the peripheral device 200 to be explained below.

The input terminal 212 receives an analogue signal output through the first speaker terminal 111 or the second speaker terminal 112 of the earphone port 110 and transmits it to the data processing unit 240 of the peripheral device 200 to be explained below.

The clock terminal (not illustrated) receives a synchronization signal output through the first and second speaker terminals 111 and 112 of the earphone port 110.

The data signal output terminal 213 outputs a data signal generated from the peripheral device 200 through the earphone port 110 of the smart device 100. Further, the ground terminal 214 is a voltage reference point and can be connected to the ground terminal 114 of the earphone port 110 of the smart device 100.

For reference, although not illustrated in FIG. 2, the earphone plug 210 of the peripheral device 200 in accordance with an illustrative embodiment may further include the clock terminal (not illustrated) that receives a synchronization signal output through the first and second speaker terminals 111 and 112 of the earphone port 110.

Returning to FIG. 1 again, a configuration and an operation of the smart device 100 in accordance with an illustrative embodiment will be explained in detail.

The connection recognition unit 120 recognizes a connection with the peripheral device 200 based on a connection signal generated when the earphone plug 210 of the peripheral device 200 is connected to the earphone port 110.

The connection recognition unit 120 can identify a connection signal generated by itself depending on a physical connection result when the earphone port 110 is connected to the earphone plug 210.

Further, the connection recognition unit 120 in accordance with an illustrative embodiment has an audio signal input and output function (for example, a sound source is played by using an earphone) which the smart device 100 typically uses through the earphone port 110 and a function of receiving a connection signal transmitted from the peripheral device 200 through the first speaker terminal 111, the second speaker terminal 112 or the microphone terminal 113 when the peripheral device 200 is connected to the smart device 100 through the earphone port 110. The connection recognition unit 120 may transmit information of the peripheral device 200 as a result of recognition about the connected peripheral device 200 to the application operating unit 130.

The application operating unit 130 receives an executive command about an existing signal processing application through an input module (not illustrated) and executes the signal processing application in response to the executive command. For reference, the input module (not illustrated) is a basic component included in the smart device 100 and receives input data generated by the smart device 100's user who physically manipulates input means (for example, a key board, a key pad, a mouse, a touch screen, and the like). By way of example, if the user selects (i.e. touches) a signal processing application corresponding to the peripheral device 200 among multiple applications displayed on a touch screen of the smart device 100, the application operating unit 130 selects and executes a signal processing application according to the application selection information (i.e. an executive command) received through the input module (not illustrated).

The application operating unit 130 in accordance with an illustrative embodiment can automatically execute a signal processing application corresponding to the peripheral device 200 recognized through the earphone port 110.

To be specific, a signal processing application executed under control of the application operating unit 130 includes an algorithm for continuously outputting a voltage of a predetermined level through the earphone port 110. Further, the signal processing application may include an algorithm that performs a predetermined signal analysis about a data signal generated from the peripheral device 200 and input through the earphone port 110 and outputs a result of the analysis, and an algorithm for analyzing a signal such that data the user wants to transmit can be transmitted to the peripheral device 200.

The application operating unit 130 extracts a signal processing application corresponding to the peripheral device 200 recognized by the connection recognition unit 120 from the application management unit 140 and executes the extracted signal processing application.

The application operating unit 130 identifies the signal processing application corresponding to the peripheral device 200 among signal processing applications stored by the application management unit 140 based on a connection signal of the recognized peripheral device 200 and executes the signal processing application.

The application management unit 140 matches various signal processing applications with their corresponding peripheral devices which are previously registered or set and stores and manages the signal processing applications.

The power supply unit 150 outputs a voltage of a predetermined level through at least one of the first and second speaker terminals 111 and 112 and the microphone terminal 113. In this case, the voltage output through the power supply unit 150 is used as power of the peripheral device 200.

To be specific, the power supply unit 150 outputs a voltage signal of a predetermined level through the first speaker terminal 111 or the second speaker terminal 112 of the earphone port 110 when the signal processing application is executed.

In this case, the power supply unit 150 continuously outputs a high-level signal through any one of the first and second speaker terminals 111 and 112. Further, the power supply unit 150 can continuously output a voltage signal of a predetermined frequency through any one of the first and second speaker terminals 111 and 112. As a signal of a predetermined level is continuously output through the speaker terminal 111 or 112 of the earphone port 110, a voltage of a predetermined level is input to the power supply terminal 211 of the earphone plug 210.

For reference, a predetermined level of a voltage supplied in an illustrative embodiment may be equal to a level of a voltage signal output when the smart device 100 plays a sound source file. That is, it is convenient to supply power to the connected peripheral device 200 by continuously outputting a voltage used by the smart device 100 when outputting a sound source signal through the speaker terminal of the earphone port 110 without additional generation of power supply from the smart device 100 or addition of a terminal for power supply to the earphone port 110.

Further, if a connection between the earphone port 110 and the earphone plug 210 of the peripheral device 200 is recognized by the connection recognition unit 120, the power supply unit 150 in accordance with another illustrative embodiment continuously outputs a basic voltage of a predetermined level through any one of the two speaker terminals 111 and 112 and the microphone terminal 113. In this case, the level of the basic voltage may be set to be equal to a level of a voltage basically output for generally using the two speaker terminals 111 and 112 and the microphone terminal 113 of the earphone port 110.

To be specific, the microphone terminal 112 of the earphone port 110 in accordance with another illustrative embodiment outputs a constant DC voltage to operate a microphone. By using this, a basic voltage of a predetermined level can be output. By way of example, in case of a smart phone, a DC voltage of about 2.7 V is output.

Meanwhile, in accordance with still another illustrative embodiment, when a signal processing application is executed, while the power supply unit 150 continuously outputs a voltage signal (i.e. a high-level signal) of a predetermined level through the first speaker terminal 111 of the earphone 110, a synchronization signal for synchronization with the peripheral device 200 may be output through the second speaker terminal 112.

Further, in accordance with still another illustrative embodiment, when a signal processing application is executed, while the power supply unit 150 continuously outputs a voltage signal (i.e. a high-level signal) of a predetermined level through the first speaker terminal 111 of the earphone 110, the data processing unit 160 to be described later may transmit a data signal for analogue communication to the peripheral device 200 through the second speaker terminal 112.

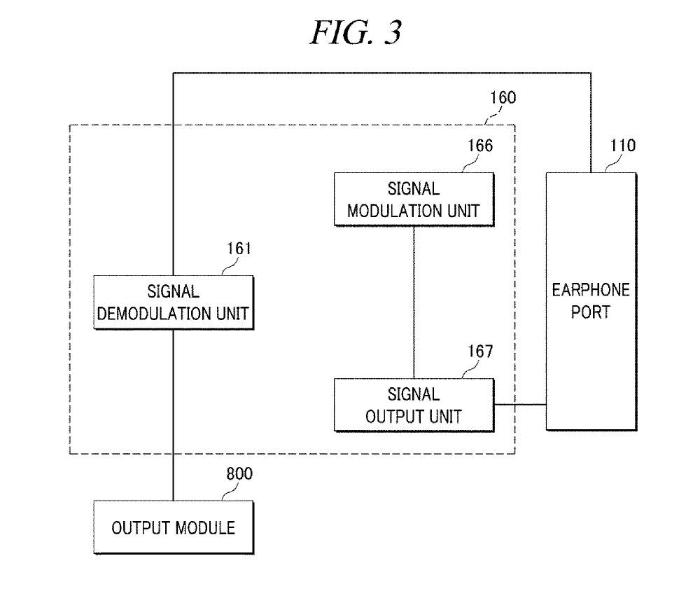

FIG. 3 illustrates a configuration of the data processing unit 160 of the smart device 100.

The data processing unit 160 in accordance with an illustrative embodiment performs a predetermined signal analysis on a data signal input from the peripheral device 200 through the microphone terminal 113 of the earphone port 110 according to an operation of a signal processing application and outputs a result of the signal analysis through a predetermined output module 800.

The output module 800 processes the result of the signal analysis so as to be output on the smart device 100 and outputs it through an output unit, such as a screen or a speaker, of the smart device 100. In this case, a data signal of the peripheral device 200 received through the microphone terminal 113 of the earphone port 110 may be a data signal modulated by a predetermined modulation method in the peripheral device 200. The data processing unit 160 may perform signal processing by demodulating the data signal by a demodulation method corresponding to the modulation method.

Further, the data processing unit 160 in accordance with another illustrative embodiment may transmit data the user wants to transmit through the first and second speaker terminals 111 and 112 of the earphone plug 210 of the peripheral device 200 according to an operation of a signal processing application. In this case, the data processing unit 160 includes a signal modulation unit 166 and a signal output unit 167.

The signal modulation unit 166 in accordance with an illustrative embodiment modulates an analogue signal corresponding to the data by a predetermined analogue signal modulation method. For reference, the signal modulation unit 166 in accordance with another illustrative embodiment directly receives digital data from the data processing unit 160 and modulates a digital data signal into an analogue signal by using a predetermined digital modulation method (for example, Amplitude Shift Keying modulation (ASK) and Frequency Shift Keying modulation (FSK)). Further, if digital data generated by the data processing unit 160 is converted into an analogue signal by the converter 115, the signal modulation unit 166 in accordance with still another illustrative embodiment modulates the converted signal by using a predetermined analogue modulation method (for example, Amplitude Modulation (AM) or Frequency Modulation (FM)). In this case, the signal modulation unit 166 may modulate the converted signal into an analogue signal having a frequency range of from about 20 Hz to about 20000 Hz which is an audible frequency range for the first and second speaker terminals 111 and 112 to transmit.

The signal output unit 167 receives an analogue data signal from the signal modulation unit 166 and transmits it to the first and second speaker terminals 111 and 112 of the earphone port 110.

Hereinafter, a configuration and an operation of the peripheral device 200 in accordance with an illustrative embodiment will be explained with reference to FIGS. 1, 2, and 4.

For reference, in accordance with an illustrative embodiment, a device connected to the earphone port 110 of the smart device 100 through an earphone plug is referred to as “peripheral device 200”. Actually, the peripheral device 200 is a data processing device capable of generating data and processing a signal. Therefore, hereinafter, for convenience of explanation, the peripheral device 200 will be referred to as “data processing device 200”.

The power supply unit 220 supplies power to each component of the data processing device 200 by using a predetermined-level voltage (i.e. a voltage received from the smart device side) transmitted from any one of the power supply terminal 211 and the data signal output terminal 213 of the earphone plug 210 and a ground voltage transmitted from the ground terminal 214.

If the voltage input through the power supply terminal 211 is a signal having a specific frequency, the power supply unit 220 may include a rectifier 221 that rectifies the input voltage to a DC voltage and outputs the DC voltage.

The data generation processing unit 230 generates data that operates a signal processing application installed in an external smart device (i.e. the smart device or the like) and transmits the generated data to the data processing unit 240.

By way of example, the data generated by the data generation processing unit 230 may be values sensed by one or more sensors provided in the data processing device 200. The data generation processing unit 230 may receive the sensed values and transmit them to the data processing unit 240. For reference, the data generation processing unit 230 may generate data by using a sensor and also generate and acquire data in various other ways.

The data processing unit 240 in accordance with an illustrative embodiment converts the received data into a data signal in the form of a frequency and transmits it to the external smart device (i.e. the smart device) through the data signal output terminal 213 of the earphone plug 210.

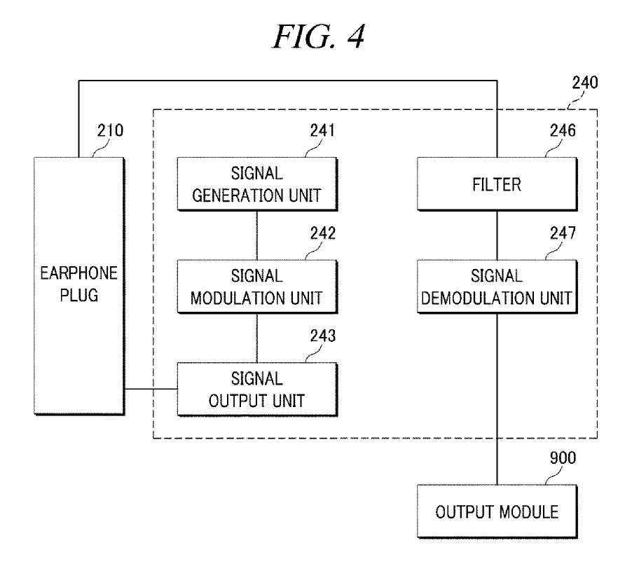

To be specific, the data processing unit 240 in accordance with an illustrative embodiment includes a configuration as depicted in FIG. 4.

FIG. 4 is a block diagram illustrating a configuration of a data processing unit of a peripheral device 240 in accordance with another illustrative embodiment.

As depicted in FIG. 4, the data processing unit 240 includes a signal generation unit 241, a signal modulation unit 242, and a signal output unit 243.

The signal generation unit 241 generates an analogue signal having a predetermined frequency and supplies it to the signal modulation unit 242.

The signal modulation unit 242 modulates the analogue signal based on data received from the data generation processing unit 230. Further, the signal modulation unit 242 transmits the modulated signal (hereinafter, referred to as “data signal”) to the signal output unit 243.

The signal modulation unit 242 in accordance with an illustrative embodiment modulates an analogue signal corresponding to the data by a predetermined analogue signal modulation method. For reference, the signal modulation unit 166 in accordance with another illustrative embodiment directly receives digital data from the data generation processing unit 230 and modulates a digital data signal into an analogue signal by using a predetermined digital modulation method (for example, Amplitude Shift Keying modulation (ASK) and Frequency Shift Keying modulation (FSK)). Further, the signal modulation unit 242 in accordance with another illustrative embodiment modulates an analogue data signal by using a predetermined analogue modulation method (for example, Amplitude Modulation (AM) or Frequency Modulation (FM)). In this case, the signal modulation unit 242 may modulate the analogue data signal into an analogue signal having a frequency range of from about 20 Hz to about 20000 Hz which is an audible frequency range for the microphone terminal 113 of the external smart device 100 to receive.

The signal output unit 243 receives the modulated data signal from the signal modulation unit 242 and outputs it toward the external smart device (i.e. the smart device) through the data signal output terminal 213 of the earphone plug 210.

Meanwhile, the data processing unit 240 in accordance with another illustrative embodiment may include a filter 246 and a signal demodulation unit 247.

For reference, the filter 246 in accordance with an illustrative embodiment filters the data signal received through the input terminal 212 of the earphone plug 210 to be a signal having an audible frequency of from about 20 Hz to about 20000 Hz. This filtering process is performed to filter noise by using a characteristic of the speaker terminal which cannot transmit a signal having a frequency of about 20 Hz or less or about 20000 Hz or more.

Further, the signal demodulation unit 247 in accordance with an illustrative embodiment demodulates the modulated data signal by a demodulation method corresponding to the modulation method of the external smart device to perform a signal analysis.

For reference, the data processing unit 240 in accordance with another illustrative embodiment may process and transmit a data signal in response to a synchronization signal transmitted through the clock terminal of the earphone plug 210.

Furthermore, the data processing unit 240 in accordance with an illustrative embodiment outputs a result of the signal analysis through a predetermined output module 900.

The output module 900 processes the result of the signal analysis so as to be output on the data processing device 200 and outputs it through an output unit, such as a screen or a speaker, of the data processing device 200.

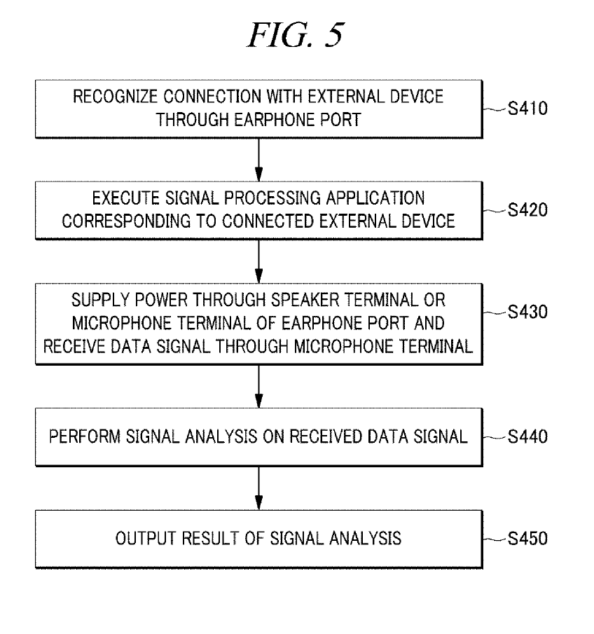

Hereinafter, a signal processing method between the smart device 100 and the peripheral device 200 in accordance with an illustrative embodiment will be explained in detail with reference to FIG. 5.

FIG. 5 is a flow chart for explaining a signal processing method using an earphone port in accordance with an illustrative embodiment.

As depicted in FIG. 5, in the signal processing method in accordance with an illustrative embodiment, a connection with a peripheral device is recognized through an earphone port of a smart device (S410).

In this case, if an earphone plug of the peripheral device is connected to the earphone port of the smart device, the smart device itself generates a connection signal corresponding to the physical connection between the earphone port and the earphone plug or a microphone terminal of the earphone port receives a connection signal output through a data signal output terminal of the earphone plug. Based on the connection signal, the connection with the peripheral device can be recognized.

For reference, the earphone port of the smart device includes a speaker terminal and the microphone terminal, and the earphone plug of the peripheral device includes a power supply terminal through which power is supplied and a data signal output terminal through which a generated data signal is output or power is supplied. The power supply terminal is supplied with power through the speaker terminal of the smart device, and the data signal output terminal is supplied with power through the microphone terminal of the smart device.

Thereafter, a signal processing application corresponding to the connected peripheral device (i.e. the recognized peripheral device) is executed (S420).

For reference, various signal processing applications respectively corresponding to various peripheral devices are installed in the smart device, and a signal processing application corresponding to the recognized peripheral device is extracted and executed.

Information of an application selected by a user of the smart device from the multiple applications installed in the smart device can be input through an input module, or a kind of an application corresponding to the connection signal input from the peripheral device can be identified.

When the signal processing application is executed, power is supplied to the peripheral device through the earphone port (the speaker terminal or the microphone terminal) of the smart device according to a preset algorithm. A data signal generated by the peripheral device is input through the microphone terminal of the smart device (S430), and a preset signal analysis on the data signal is performed according to an operation of the signal processing application (S440).

To be specific, the signal processing application in accordance with an illustrative embodiment includes an algorithm for continuously outputting a voltage of a predetermined level through the speaker terminal of the earphone port of the smart device. By way of example, while the signal processing application is executed, a high-level signal is continuously output to the speaker terminal of the earphone port. In this case, if the high-level signal is continuously output through the speaker terminal, a voltage output typically when the smart device plays a sound source file is continuously output and supplied as power to the peripheral device.

Further, the signal processing application may further include an algorithm for outputting the above-described voltage for power supply through any one of the speaker terminals (i.e. a left speaker or a right speaker) of the earphone port and for outputting a signal for synchronization with the peripheral device through the other speaker terminal.

Furthermore, the signal processing application may further include an algorithm for analyzing a data signal of the peripheral device input through the microphone terminal of the earphone port of the smart device by a preset signal processing method.

There has been explained that while the signal processing application is executed, the voltage signal is continuously output through the speaker terminal according to the signal processing method using the earphone port in accordance with an illustrative embodiment. However, before the signal processing application is executed in step S420, a basic voltage may be output through any one of the speaker terminal or the microphone terminal and supplied as power to the peripheral device. That is, when a connection between the earphone port of the smart device and the earphone plug of the peripheral device is recognized, a voltage equal to the basic voltage output for generally using the speaker terminal and the microphone terminal in the smart device may be continuously output and supplied as power to the peripheral device.

Then, a result of the signal analysis is output through a predetermined output module of the smart device (S450).

The output module processes the result of the signal analysis so as to be output on the smart device and outputs it through an output unit such as a screen or a speaker of the smart device.

As described above, signal processing with respect to the peripheral device is performed by using the earphone port, and, thus, even if the peripheral device connected to the smart device does not include an additional power supply, the peripheral device can readily receive power supplied from the smart device through the earphone plug. Further, the smart device can supply power to the peripheral device and perform a signal analysis by using the existing earphone port without modification to the constitution of the smart device. Furthermore, the smart device receives a data signal transmitted from the peripheral device by using the earphone port and executes a signal processing application that performs predetermined signal analyses corresponding to various peripheral devices. Therefore, it is possible to rapidly and conveniently perform signal processing with respect to the peripheral device.

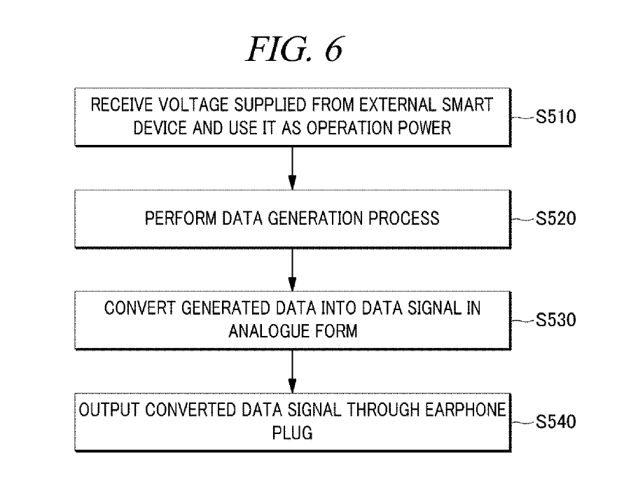

Hereinafter, a data processing method of a data processing device (i.e. a peripheral device) through a connection between an earphone port of anther external smart device (i.e. a smart device) and an earphone plug of the data processing device in accordance with an illustrative embodiment will be explained in detail with reference to FIG. 6.

FIG. 6 is a flow chart for explaining a data processing method of a peripheral device in accordance with an illustrative embodiment.

A data generation process for operating a signal processing application installed in another peripheral device is performed (S520).

By way of example, generated data may be values sensed by one or more sensors provided in a peripheral device (hereinafter, referred to as “data processing device”), and data may be generated and acquired by using a sensor and also generated and acquired in various other ways.

Then, the generated data are converted into a data signal in the form of a predetermined frequency (S530).

The data are applied to an analogue signal in the form of a predetermined frequency so as to be converted into a data signal. The data signal may be generated through modulation by a predetermined modulation method.

Thereafter, the converted data signal is output through a data signal output terminal of the earphone plug (S540).

The output data signal is input through a microphone terminal of the earphone port of the external smart device (i.e. the smart device).

As described above, the data processing device connected to the external smart device through the earphone plug modulates data to be in the form of a predetermined frequency and transmits them to another device through the earphone plug. Thus, it is possible to conveniently perform signal processing between the devices.

Meanwhile, FIG. 6 illustrates the signal processing method in which the data processing device in accordance with an illustrative embodiment transmits data to the another external smart device through the earphone plug. However, if the earphone plugs of the data processing device is connected to an earphone port of another device before step S520, the data processing device receives power supplied from the another external smart device through a power supply terminal or a data signal output terminal of the earphone plug and uses the power (S510).

Thus, the data processing device connected to the external smart device can be readily supplied with power from another device through the earphone plug without addition of a power supply.

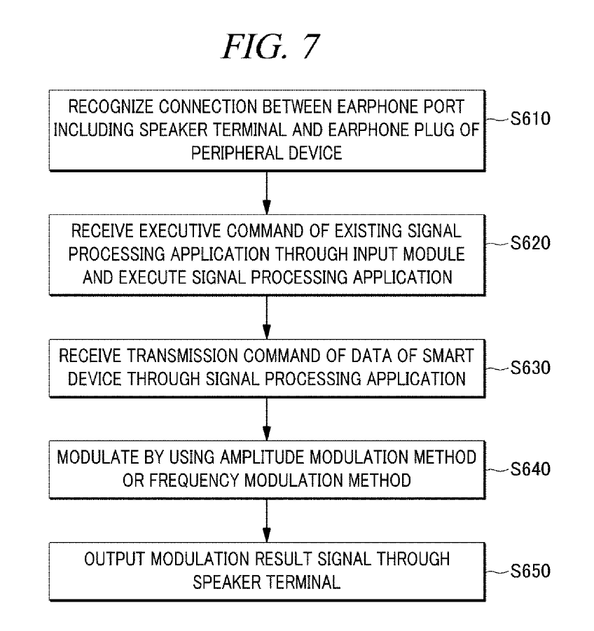

Hereinafter, a signal processing method of the smart device 100 with respect to the peripheral device 200 in accordance with another illustrative embodiment will be explained in detail with reference to FIG. 7.

FIG. 7 is a flow chart for explaining a signal processing method using an earphone port in accordance with another illustrative embodiment.

As depicted in FIG. 7, in the signal processing method in accordance with another illustrative embodiment, a connection with a peripheral device is recognized through an earphone port of a smart device (S610).

In this case, if an earphone plug of the peripheral device is connected to the earphone port of the smart device, the smart device itself generates a connection signal corresponding to the physical connection between the earphone port and the earphone plug or a microphone terminal of the earphone port receives a connection signal output through a data signal output terminal of the earphone plug. Based on the connection signal, the connection with the peripheral device can be recognized.

For reference, the earphone port of the smart device includes a speaker terminal and/or the microphone terminal, and the earphone plug of the peripheral device includes a power supply terminal through which power is supplied, an input terminal through which an analogue signal is received, and a data signal output terminal through which a generated data signal is output or power from the microphone terminal is supplied.

Thereafter, a signal processing application corresponding to the connected peripheral device (i.e. the recognized peripheral device) is executed (S620).

For reference, various signal processing applications respectively corresponding to various peripheral devices are installed in the smart device, and a signal processing application corresponding to the recognized peripheral device is extracted and executed.

Information of an application selected by a user of the smart device from the multiple applications installed in the smart device can be input through an input module, or a kind of an application corresponding to the connection signal input from the peripheral device can be identified.

When the signal processing application is executed, power is supplied to the peripheral device through the earphone port (the speaker terminal or the microphone terminal) of the smart device according to a preset algorithm. A transmission command of data is received by the smart device through the signal processing application (S630), and the data signal is modulated by using an amplitude modulation method or a frequency modulation method according to an operation of the signal processing application (S640).

To be specific, the signal processing application in accordance with an illustrative embodiment may be executed according to an algorithm for continuously outputting a voltage of a predetermined level through the speaker terminal or the microphone terminal of the earphone port of the smart device. By way of example, while the signal processing application is executed, a high-level signal is continuously output to the speaker terminal of the earphone port. In this case, if the high-level signal is continuously output through the speaker terminal, a voltage output typically when the smart device plays a sound source file is continuously output and supplied as power to the peripheral device.

Further, the microphone terminal of the earphone port in accordance with an illustrative embodiment outputs a constant DC voltage to operate a microphone. The signal processing application may be executed according to an algorithm for continuously outputting voltage of a predetermined level by using this.

Further, the signal processing application may further include an algorithm for outputting the above-described voltage for power supply through any one of the speaker terminals (i.e. a left speaker or a right speaker) of the earphone port and for outputting a signal for synchronization with the peripheral device through the other speaker terminal.

Furthermore, the signal processing application may further include an algorithm for analyzing a data signal of the smart device output through the speaker terminal of the earphone port of the smart device by a preset signal processing method. The algorithm for analyzing a data signal includes an algorithm for modulating a data signal for analogue communication with the peripheral device and outputting the modulation result data signal to the peripheral device.

There has been explained that while the signal processing application is executed, the voltage signal is continuously output through the speaker terminal according to the signal processing method using the earphone port in accordance with an illustrative embodiment. However, before the signal processing application is executed in step S620, a basic voltage may be output through any one, which does not output a result signal of the signal analysis, of a first speaker terminal, a second speaker terminal or the microphone terminal and supplied as power to the peripheral device. That is, when a connection between the earphone port of the smart device and the earphone plug of the peripheral device is recognized, a voltage equal to the basic voltage output for generally using the speaker terminal and the microphone terminal in the smart device may be continuously output and supplied as power to the peripheral device.

Then, a result of the signal analysis is output through the speaker terminal (S650).

As described above, signal processing with respect to the peripheral device is performed by using the earphone port, and, thus, even if the peripheral device connected to the smart device does not include an additional power supply, the peripheral device can readily receive power supplied from the smart device through the earphone plug. Further, the smart device can supply power to the peripheral device and perform analogue communication by using the existing earphone port without modification to the constitution of the smart device. Furthermore, the data processing device connected to another peripheral device through an earphone port modulates data to be in the form of a predetermined frequency and transmits them to another device through the earphone port. Thus, it is possible to conveniently perform signal processing between the devices.

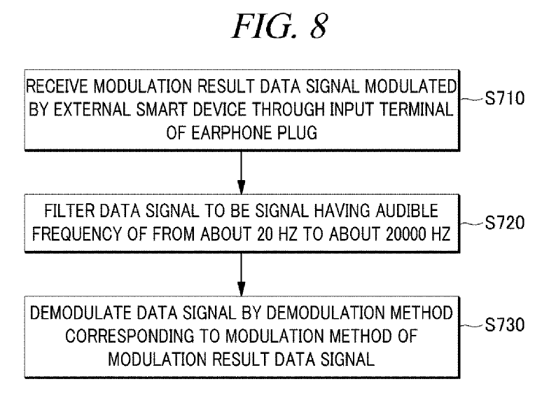

Hereinafter, a data processing method of a data processing device (i.e. a peripheral device) through a connection between an earphone port of anther external smart device (i.e. a smart device) and an earphone plug of the data processing device in accordance with an illustrative embodiment will be explained in detail with reference to FIG. 8.

FIG. 8 is a flow chart for explaining a data processing method of a peripheral device in accordance with an illustrative embodiment.

If an earphone port of an external smart device is connected to an earphone plug, a modulation result data signal modulated by the external smart device is received through an input terminal of the earphone plug (S710).

When the earphone plug is connected to the earphone port of the external smart device, the input terminal is connected to a speaker terminal of the earphone port.

Then, in a data processing method of a peripheral device in accordance with an illustrative embodiment, the data signal is filtered to be a signal having an audible frequency of from about 20 Hz to about 20000 Hz (S720). This filtering process is performed to filter noise by using a characteristic of the speaker terminal which cannot transmit a signal having a frequency of about 20 Hz or less or about 20000 Hz or more.

Thereafter, the data signal is demodulated by a demodulation method corresponding to a modulation method of the modulation result data signal (S730).

In accordance with an illustrative embodiment, the data processing method may further include outputting the demodulated data signal through a data signal output module of the peripheral device after step (S730) for demodulation.

To be specific, the output module processes the result of the signal analysis so as to be output on the peripheral device and outputs it through an output unit, such as a screen or a speaker, of the peripheral device.

As described above, the peripheral device receives and processes a data signal transmitted from the external smart device by using the earphone plug and further performs a predetermined signal analysis. Thus, it is possible to rapidly and conveniently perform analogue communication with the peripheral device.

Meanwhile, FIG. 8 illustrates the signal processing method in which the data processing device in accordance with an illustrative embodiment receives data from the another external smart device through the earphone plug. However, if the earphone plugs of the data processing device is connected to an earphone port of another device before step S710, the data processing device receives power supplied from the another external smart device through a power supply terminal or a data signal output terminal of the earphone plug and uses the power.

Thus, the data processing device connected to the external smart device can be readily supplied with power from another device through the earphone plug without addition of a power supply.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

What is claimed is:

1. A smart device for performing signal processing with respect to a peripheral device by using an earphone port, the smart device comprising:
an earphone port that includes a speaker terminal and a microphone terminal and receives a signal from an earphone plug of the peripheral device connected to the smart device;
a connection recognition unit that recognizes a connection between the earphone plug of the peripheral device and the earphone port;
an application operating unit that receives an executive command of an existing signal processing application through an input module and executes the signal processing application in response to the executive command; and
a data processing unit that performs a predetermined signal analysis on a data signal input from the peripheral device through the microphone terminal according to an operation of the executed signal processing application and outputs a result of the signal analysis through an output module.

2. The smart device of claim 1, further comprising:
a power supply unit that outputs a voltage of a predetermined level through the speaker terminal or the microphone terminal when the operation of the signal processing application or the connection with the peripheral device is checked.

3. The smart device of claim 2,
wherein when the voltage is output, the power supply unit continuously outputs a high-level signal or a signal having a predetermined frequency through the speaker terminal.

4. The smart device of claim 1,
wherein the data processing unit comprises:
a signal demodulation unit that receives a data signal modulated by the peripheral device by a predetermined modulation method and demodulates the data signal by a demodulation method corresponding to the modulation method.

5. The smart device of claim 1, further comprising:
a signal modulation unit that receives a transmission command of data through the signal processing application and modulates the data to be a signal having a specific frequency range for analogue communication with the peripheral device; and
a signal output unit that outputs a modulation result signal received from the signal modulation unit through the speaker terminal.

6. The smart device of claim 5,
wherein the signal modulation unit receives the transmission command of the data through the signal processing application and modulates the data by an amplitude modulation method using a specific carrier wave of from about 20 Hz to about 22000 Hz or modulates the data to be a signal having a frequency range of from about 20 Hz to about 22000 Hz by a frequency modulation method.

7. A signal processing method using an earphone port in which a smart device processes a signal with respect to a peripheral device by using an earphone port, the signal processing method comprising:
recognizing a connection between the earphone port including a speaker terminal and a microphone terminal and an earphone plug of the peripheral device;
supplying a voltage of a predetermined level through the microphone terminal or the speaker terminal according to an operation of an existing signal processing application;
receiving a data signal from the peripheral device through the microphone terminal;
performing a predetermined signal analysis on the received data signal from the peripheral device according to an operation of the signal processing application; and
outputting a result of the signal analysis through an output module.

8. The signal processing method using an earphone port of claim 7,
wherein the supplying a voltage of a predetermined level through the speaker terminal comprises:
continuously outputting a high-level signal or a signal having a predetermined frequency and supplying a voltage of a predetermined level to the peripheral device.

9. The signal processing method using an earphone port of claim 7,
wherein the performing a predetermined signal analysis comprises:
demodulating the data signal modulated by the peripheral device by a predetermined modulation method by a demodulation method corresponding to the modulation method.

10. The signal processing method using an earphone port of claim 7, further comprising:
before the outputting a result of the signal analysis,
receiving a transmission command of data of the smart device through the signal processing application;
modulating the data to be a signal having a specific frequency range for analogue communication with the peripheral device; and
outputting the modulated signal through the speaker terminal.

11. A data processing device connected to an earphone port of an external smart device through an earphone plug, the data processing device comprising:
an earphone plug that includes a data signal output terminal;
a data generation processing unit that generates data for operating a signal processing application installed in the external smart device connected through the earphone plug;
a signal generation unit that generates an analogue signal having a predetermined frequency;
a signal modulation unit that modulates the analogue signal based on the data generated by the data generation processing unit; and
a signal output unit that outputs the signal modulated by the signal modulation unit through the data signal output terminal,
wherein when the earphone plug is connected to the earphone port of the external smart device, the data signal output terminal is connected to a microphone terminal of the earphone port.

12. The data processing device of claim 11,
wherein the signal modulation unit modulates the analogue signal by an amplitude modulation method using a carrier wave of from about 20 Hz to about 22000 Hz or modulates the analogue signal to be a signal having a frequency range of from about 20 Hz to about 22000 Hz by a frequency modulation method based on the data generated by the data generation processing unit.

13. The data processing device of claim 11, further comprising:
a power supply unit that receives a voltage supplied from the external smart device and uses the voltage as operation power.

14. The data processing device of claim 13,
wherein the earphone plug further comprises:
a power supply terminal that is connected to a speaker terminal of the earphone port to receive a voltage supplied from the external smart device.

15. The data processing device of claim 14,
wherein the power supply terminal comprises:
a rectifier that receives a voltage signal having a predetermined frequency through the power supply terminal and rectifies the voltage to a DC voltage.

16. The data processing device of claim 13,
wherein the data signal output terminal receives a voltage of a predetermined level continuously output through the microphone terminal of the earphone port and outputs the voltage through the power supply unit.

17. The data processing device of claim 11,
wherein the earphone plug further comprises:
an input terminal that receives a data signal modulated by the external smart device from the external smart device,
the data processing device further comprises:
a signal demodulation unit that receives the data signal from the earphone plug and demodulates the data signal by a demodulation method corresponding to a modulation method of the data signal, and
when the earphone plug is connected to the earphone port of the external smart device, the input device is connected to a speaker terminal of the earphone port.

18. The data processing device of claim 17, further comprising:
a filter that receives the data signal through the input terminal, extracts an analogue signal of from about 20 Hz to about 20000 Hz, and transmits a result thereof to the signal demodulation unit.

19. A data processing method of a data processing device connected to an earphone port of an external smart device through an earphone plug, the data processing method comprising:
receiving a voltage supplied from the external smart device through a power supply terminal of the earphone plug or a data signal output terminal and using the voltage as operation power;
generating data for operating a signal processing application installed in the external smart device;
modulating analogue signal having a predetermined frequency based on the data; and
outputting the modulated signal through a data signal output terminal of the earphone plug,
wherein when the earphone plug is connected to the earphone port of the external smart device, the power supply terminal is connected to a speaker terminal of the earphone port and the data signal output terminal is connected to a microphone terminal of the earphone port.

20. The data processing method of claim 19, further comprising:
before the generating data,
receiving a modulation result data signal modulated by the external smart device; and
after the generating data,
if the data signal is input, demodulating the data signal by a demodulation method corresponding to a modulation method of the modulation result data signal,
wherein when the earphone plug is connected to the earphone port of the external smart device, the input terminal is connected to the speaker terminal of the earphone port.
